(19) United States
(12) Patent Application Publication
(10) Pub. No.: US 2015/0307721 A1
(43) Pub. Date: Oct. 29, 2015

(54) COATING COMPOSITION FOR LAYER HAVING LOW REFRACTIVE INDEX, AND TRANSPARENT CONDUCTIVE FILM INCLUDING SAME

(71) Applicant: LG HAUSYS, LTD., Yeongdeungpo-gu Seoul (KR)

(72) Inventors: Ji Yeon SEO, Anyang-si, Gyeonggi-do (KR); Won Kook KIM, Daejeon (KR); Heon Jo KIM, Suwon-si, Gyeonggi-do (KR); Mu Seon RYU, Seoul (KR); Jin Ki HONG, Seoul (KR)

(73) Assignee: LG HAUSYS, LTD., Yeongdeungpo-gu Seoul (KR)

(21) Appl. No.: 14/650,209

(22) PCT Filed: Nov. 8, 2013
(86) PCT No.: PCT/KR2013/010111

§ 371 Date: Jun. 5, 2015

(30) Foreign Application Priority Data
Dec. 11, 2012 (KR) 10-2012-0143302

(51) Int. Cl. C09D 5/24; C09D 183/06

(52) U.S. Cl. CPC C09D 5/24; C09D 183/06

(57) ABSTRACT

Provided is a coating composition for a layer having a low refractive index and comprising a siloxane compound and a metal salt. In addition, provided is a transparent conductive film including the layer having a low refractive index and formed by using the coating composition for a layer having a low refractive index.

### TECHNICAL FIELD

The present invention relates to a coating composition for a low refractive-index layer and a transparent conductive film including the same.

### BACKGROUND ART

Touch panels are classified into optical touch panels, surface acoustic wave touch panels, capacitive touch panels, resistive touch panels, and the like according to the method of detecting touch position. A resistive touch panel includes a transparent conductive film and a glass sheet having a transparent conductor layer attached thereto and placed opposite the transparent conductive film, with spacers interposed therebetween, wherein an electric current is passed through the transparent conductive film such that the voltage across the glass sheet having the transparent conductor layer attached thereto is measured. On the other hand, a capacitive touch panel is essentially composed of a substrate and a transparent conductive layer on the substrate, is characterized by absence of movable portions, and is applied to in-vehicle devices or the like by virtue of high durability and high transmittance thereof.

Typically, a transparent conductive film used in these touch panels is formed with an under coating layer and a conductive layer which are sequentially stacked on one surface of a transparent film substrate. In this regard, Japanese Patent Laid-open Publication No. 2003-197035 discloses a transparent conductive film formed with an under coating layer between a base film and a conductive layer. Recently, in addition to studies on such a transparent conductive film, continuous studies on an undercoating layer composition are being made to secure that the index of refraction of an under coating layer constituting the transparent conductive film can be adjusted while ensuring durability of the under coating layer.

### DISCLOSURE

### Technical Problem

It is one aspect of the present invention to provide a coating composition for a low refractive-index layer, which includes a siloxane compound and a metal salt, thereby allowing a low refractive-index layer to have a tight bonding structure and to be prevented from damage caused by the surrounding environment.

It is another aspect of the present invention to provide a transparent conductive film formed using the coating composition for a low refractive-index layer as set forth above.

### Technical Solution

In accordance with one aspect of the present invention, a coating composition for a low refractive-index layer includes a siloxane compound and a metal salt.

The metal salt may include a salt of at least one metal selected from the group consisting of zinc, yttrium, trivalent chromium, di- and trivalent cobalt, nickel, magnesium, aluminum, mono- and divalent copper, trivalent iron, cadmium, antimony, mercury, rubidium, vanadium, and combinations thereof.

The metal salt may include at least one salt selected from the group consisting of nitrates, sulfates, carboxylates, halides, alkoxides, acetyl acetonate, and combinations thereof.

The metal salt may be present in an amount of about 0.1% by weight (wt %) to about 1.0 wt % based on the total weight (100 wt %) of the coating composition.

The siloxane compound may include a siloxane polymer selected from the group consisting of tetramethoxysilane, tetraethoxysilane, methyltrimethoxysilane, glycidyloxypropyltrimethoxysilane, and combinations thereof.

The siloxane polymer may have a molecular weight of about 1,000 to about 50,000.

The siloxane compound may be present in an amount of about 5 wt % to about 100 wt % based on the total weight (100 wt %) of the coating composition.

In accordance with another aspect of the present invention, a transparent conductive film includes a low refractive-index layer formed using the coating composition for a low refractive-index layer as set forth above.

The transparent conductive film may have a laminate structure of a transparent substrate, a high refractive-index layer, the low refractive-index layer, and a conductive layer.

The low refractive-index layer may have an index of refraction of about 1.4 to about 1.5.

The low refractive-index layer may have a thickness of about 5 nm to about 100 nm.

The high refractive-index layer may have a thickness of about 20 nm to about 150 nm.

The transparent substrate may be a monolayer or multilayer film including any one selected from the group consisting of polyethylene terephthalate (PET), polyethylene naphthalate (PEN), polyethersulfone (PES), polycarbonate (PC), polypropylene (PP), polyvinyl chloride (PVC), polyethylene (PE), polymethyl methacrylate (PMMA), ethylene vinyl alcohol (EVA), polyvinyl alcohol (PVA), and combinations thereof.

The conductive layer may include indium tin oxide (ITO) or fluorine-doped tin oxide (FTO).

The transparent conductive film may further include a hard coating layer on one or both surfaces of the transparent substrate.

### Advantageous Effects

Use of the coating composition for a low refractive-index layer can secure a low refractive-index layer having good coatability, optical properties, and barrier properties.

The transparent conductive film can exhibit good resistance to an etching solution of acid or alkali type, while reducing resistance of a conductive layer.

### DESCRIPTION OF DRAWINGS

FIG. 1 is a schematic sectional view of a transparent conductive film according to one embodiment of the present invention.

FIG. 2 is a schematic sectional view of a transparent conductive film according to another embodiment of the present invention.

### BEST MODE

Hereinafter, embodiments of the present invention will be described in detail. However, it should be understood that the present invention is not limited to the following embodiments and should be defined only by the accompanying claims and equivalents thereof.

Portions irrelevant to the description will be omitted for clarity. Like components will be denoted by like reference numerals throughout the specification.

In the drawings, thicknesses of various layers and regions are enlarged for clarity, and thicknesses of some layers and regions are exaggerated for convenience.

It will be understood that when an element such as a layer, film, region or substrate is referred to as being placed “above (or below)” or “on (or under)” another element, it can be directly placed on the other element, or intervening layer(s) may also be present.

Coating Composition for Low Refractive-Index Layer

In accordance with one embodiment of the present invention, a coating composition for a low refractive-index layer includes a siloxane compound and a metal salt.

In formation of a transparent conductive film, after annealing at high temperature for crystallization subsequent to deposition of a conductive layer on a low refractive-index layer, the respective areas of the conductive layer generally have different conductivities, since volatile gases and moisture generated from a transparent substrate disrupt crystallization of the conductive layer. In addition, there are problems in that deterioration in visibility is caused by difference in index of refraction between a conductive layer, a low refractive-index layer, and a high refractive-index layer, and that the low refractive-index layer suffers from breakage during etching for patterning of the conductive layer.

Since the coating composition for a low refractive-index layer includes a siloxane compound and a metal salt at the same time, the coating composition can impart barrier properties to a low refractive-index layer formed using the composition. As a result, it is possible to prevent volatile gases and moisture from a transparent substrate from affecting a conductive layer, thereby reducing decrease in conductivity of the conductive layer. In addition, it is possible to prevent damage by an etching solution such as acids, alkalis, or the like, and to reduce resistance of the conductive layer while securing enhanced physical properties.

Further, since a siloxane compound has a low index of refraction, when a low refractive-index layer is formed using the coating composition for a low refractive-index layer including a siloxane compound and a metal salt, it is possible to realize good visibility through adjustment of the index of refraction and thickness of the low refractive-index layer.

The coating composition for a low refractive-index layer may include a metal salt. As used herein, the metal salt refers to a metal compound that is generated together with water upon neutralization of a metal-containing acid. When the coating composition includes the metal salt, it is possible to prevent volatile gases generated from a transparent substrate during annealing at high temperature after formation of a conductive layer from contacting the conductive layer, thereby preventing reduction in conductivity after crystallization of the conductive layer. In addition, since the coating composition includes a siloxane compound and the metal salt, the coating composition can have a tight bonding structure, thereby forming a densified low refractive-index layer.

The metal salt may include a salt of at least one metal selected from the group consisting of zinc, yttrium, trivalent chromium, di- and trivalent cobalt, nickel, magnesium, aluminum, mono- and divalent copper, trivalent iron, cadmium, antimony, mercury, rubidium, vanadium, and combinations thereof, although the metal salt is not limited thereto and may include any typical transition metal having conductivity. Alternatively, the metal salt may include at least one salt selected from the group consisting of nitrates, sulfates, carboxylates, halides, alkoxides, acetylacetonate, and combinations thereof.

The metal salt may be present in an amount of about 0.1 wt % to about 1.0 wt % based on the total weight (100 wt %) of the coating composition. Within this range, coatability of the coating composition for a low refractive-index layer can be ensured and, upon coating with the composition, gelation of the composition can be promoted, thereby increasing curing rate. Further, since the metal salt can fill voids during formation of a low refractive-index layer, it is possible to improve chemical resistance of the low refractive-index layer.

The coating composition for a low refractive-index layer may include a siloxane compound. The siloxane compound may include a siloxane polymer selected from the group consisting of tetramethoxysilane, tetraethoxysilane, methyltrimethoxysilane, glycidyloxypropyltrimethoxysilane, and combinations thereof.

Specifically, the siloxane compound may include a siloxane polymer represented by Formula 1:

(R₁)ₙ—Si—(O—R₂)₄₋ₙ

where R1 is a C₁ to C₁₈ alkyl group, a C₁ to C₁₈ vinyl group, a C₁ to C₁₈ allyl group, a C₁ to C₁₈ epoxy group, or a C₁ to C₁₈ acrylic group; R2 is a C₁ to C₆ alkyl group or a C₁ to C₆ acetoxy group; and n is an integer satisfying 0<n<4.

Thus, examples of the siloxane compound may include, in addition to the aforementioned siloxane polymers, at least one siloxane polymer selected from the group consisting of triethoxy(ethyl)silane (C₂H₅Si(OC₂H₅)₃), triacetoxy(methyl)silane ((CH₃CO₂)₃SiCH₃), triacetoxy(vinyl)silane ((CH₃CO₂)₃SiCH═CH₂), tris(2-methoxyethoxy)(vinyl)silane ((CH₃OCH₂CH₂O)₃SiCH═CH₂), trimethoxy(octyl)silane ((CH₃(CH₂)₇Si(OC₂H₅)₃), trimethoxy[2-(7-oxabicyclo[4.1.0]hept-3-yl)ethyl] silane (C₁₁H₂₂O₄Si), trimethoxy(propyl)silane (CH₃CH₂CH₂Si(OCH₃)₃), trimethoxy(oxyl)silane (CH₃(CH₂)₇Si(OCH₃)₃), trimethoxy(octadecyl)silane (CH₃(CH₂)₁₇Si(OCH₃)₃), isobutyl(trimethoxy)silane ((CH₃)₂CHCH₂Si(OCH₃)₃), triethoxy(isobutyl)silane ((CH₃)₂CHCH₂Si(OC₂H₅)₃), trimethoxy(7-octen-1-yl)silane (H₂C═CH(CH₂)₆Si(OCH₃)₃), trimethoxy(2-phenylethyl)silane (C₆H₅CH₂CH₂Si(OCH₃)₃), dimethoxy-methyl(3,3,3-trifluoropropyl)silane (C₆H₁₃F₃O₂Si), dimethoxy(dimethyl)silane (C₂H₆Si(OC₂H₆)₂), triethoxy(1-phenylethenyl)silane ((C₂H₅O)₃SiC(CH₂)C₆H₅), triethoxy[4-(trifluoromethyl)phenyl]silane (CF₃C₆H₄Si(OC₂H₅)₂), triethoxy(4-methoxyphenyl)silane ((C₂H₅O)₃SiC₆H₄OCH₃), 3-(trimethoxysilyl)propyl methacrylate (H₂C═C(CH₃)CO₂(CH₂)₃Si(OCH₃)₃), (3-glycidoxy)methyldiethoxysilane (C₁₁H₂₄O₄Si), 3-(triethoxysilyl)propylisocyanate ((C₂H_{S}O)₃Si(CH₂)₃NCO), isobutyltriethoxysilane ((CH₃)₂CHCH₂Si(OC₂H₅)₃), and combinations thereof.

The siloxane polymer may have a molecular weight of about 1,000 to about 50,000. When the siloxane polymer, represented by Formula 1, has a molecular weight within this range, the coating composition for a low refractive-index layer can secure coatability while providing optical properties and chemical resistance to a thin film during formation of a low refractive-index layer.

More specifically, the siloxane compound may be present in an amount of about 5 wt % to about 100 wt % based on the total weight (100 wt %) of the composition. Within this range, a low refractive-index layer that allows control of index of refraction and exhibits good transmittance and reflectance can be easily realized, in that the siloxane compound has an influence on the index of refraction and optical properties of the coating composition for a low refractive-index layer.

Transparent Conductive Film

In accordance with another embodiment of the present invention, a transparent conductive film includes a low refractive-index layer formed using the coating composition for a low refractive-index layer including the siloxane compound and the metal salt.

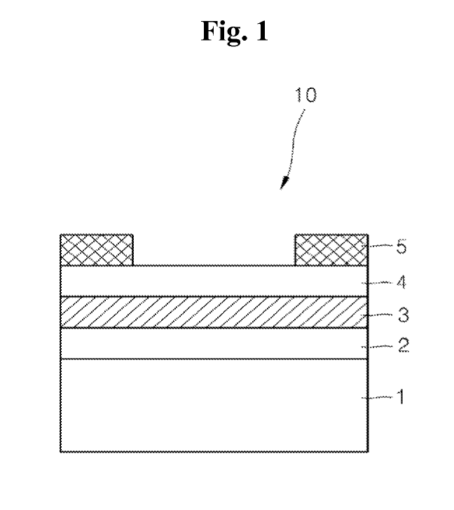

FIG. 1 is a schematic sectional view of a transparent conductive film according to one embodiment of the present invention. Referring to FIG. 1, the transparent conductive film 10 has a laminate structure of a transparent substrate 1, a hard coating layer 2, a high refractive-index layer 3, a low refractive-index layer 4, and a conductive layer 5.

The transparent substrate 1 may include a film having good transparency and strength. Specifically, the transparent substrate 1 may be a monolayer or multilayer film including any one selected from the group consisting of polyethylene terephthalate (PET), polyethylene naphthalate (PEN), polyethersulfone (PES), polycarbonate (PC), polypropylene (PP), polyvinyl chloride (PVC), polyethylene (PE), polymethyl methacrylate (PMMA), ethylene vinyl alcohol (EVA), polyvinyl alcohol (PVA), and combinations thereof.

The high refractive-index layer 3 and the low refractive-index layer 4 serve to improve insulation properties and light transmission between the transparent substrate 1 and the conductive layer 5, and the low refractive-index layer may be formed using the coating composition for a low refractive-index layer as set forth above.

A typical low refractive-index layer is required to have optical properties such as transmittance, haze, and the like as well as barrier properties to prevent reduction in conductivity in pattering of a conductive layer. Thus, when a low refractive-index layer having a predetermined thickness is formed using the coating composition for a low refractive-index layer including the siloxane compound and the metal salt, it is possible to increase transmittance while reducing transmissive b* and reflective b* values.

In addition, since all possible voids in case of using the siloxane compound alone can be filled with the metal salt, it is possible to impart barrier properties to the low refractive-index layer, which allows crystallization of the conductive layer to be unaffected by volatile gases or the like, and allows the low refractive-index layer to be prevented from breakage even under the presence of acids or alkalis, thereby providing good visibility.

The low refractive-index layer 4 may have an index of refraction of about 1.4 to about 1.5. Since the low refractive-index layer is formed using the coating composition for a low refractive-index layer including a siloxane compound having a low index of refraction, the index of refraction of the low refractive-index layer can be adjusted to about 1.4 to about 1.5. Further, difference in index of refraction between the low refractive-index layer and the high low refractive-index layer can also be adjusted, whereby the transparent conductive film can exhibit enhanced overall visibility.

The low refractive-index layer 4 may have a thickness of about 5 nm to about 100 nm. As used herein, pattern hiding properties mean having no difference in transmittance, reflectance, or color difference value between portions containing conductive materials and portions free from conductive materials after patterning the conductive layer on the low refractive-index layer. In order to hide patterns, it is important to maintain the index of refraction and thickness of the low refractive-index layer under the conductive layer at a predetermined level. Thus, when the thickness of the low refractive index is maintained at a predetermined level, it is possible to easily realize pattern hiding properties (index matching).

The high refractive-index layer 3 may have a thickness of about 20 nm to 150 nm. Within this range, it is possible to provide good transmittance and enhanced visibility while reducing cracking and curling due to stress.

The conductive layer 5 is formed on the low refractive-index layer 4, and may include indium tin oxide (ITO) or fluorine-doped tin oxide (FTO). Specifically, the conductive layer 5 may have a thickness of about 5 nm to about 50 nm. Within this range, there is an advantage in that the conductive layer can secure low resistance.

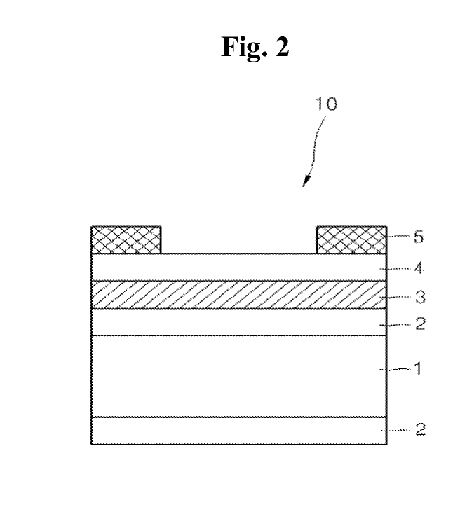

FIG. 2 is a schematic sectional view of a transparent conductive film according to another embodiment of the present invention, and a hard coating layer 2 is shown further formed under the transparent substrate 1. The hard coating layer 2 serves to enhance surface hardness and may be any compound typically used to form a hard coating layer, for example, acrylic compounds, without limitation.

While the hard coating layer 2 may only be formed on one surface of the transparent substrate 1, as shown in FIG. 1, it should be understood that the hard coating layer may be formed on both surfaces of the transparent substrate 1.

Hereinafter, the present invention will be described in more detail with reference to some examples. It should be understood that these examples are provided for illustration only and are not to be construed in any way as limiting the present invention.

### PREPARATIVE EXAMPLE

### Preparative Examples 1-1 to 1-4

### Coating Composition for Low Refractive-Index Layer

Tetraethoxy orthosilicate (TEOS), ethanol, and water were mixed in a ratio of 1:2:2, followed by adding nitric acid and reacting for 24 hours, thereby preparing a silica sol having an index of refraction of 1.43. The prepared silica sol was measured as to solid content, followed by diluting with methylethylketone (MEK), thereby preparing a siloxane compound with a solid content of 10%.

The prepared siloxane compound was mixed with a metal salt listed in Table 1, followed by diluting with methylethylketone (MEK), thereby preparing a coating composition for a low refractive-index layer with a total solid content of 5% (Preparative Examples 1-1 to 1-4).

### PREPARATIVE EXAMPLE 1-5

### Coating Composition for Low Refractive-Index Layer

Tetraethoxy orthosilicate (TEOS) containing a small amount of methyltrimethoxysilane, ethanol, and water were mixed in a ratio of 1:2:2, followed by adding nitric acid and reacting for 24 hours, thereby preparing a silica sol having an index of refraction of 1.43. The prepared silica sol was measured as to solid content, followed by diluting with methylethylketone (MEK), thereby preparing a siloxane compound with a solid content of 10%.

### PREPARATIVE EXAMPLE 1-6

### Coating Composition for Low Refractive-Index Layer

Tetraethoxy orthosilicate (TEOS), ethanol, and water were mixed in a ratio of 1:2:2, followed by adding nitric acid and reacting for 24 hours, thereby preparing a silica sol having an index of refraction of 1.43. The prepared silica sol was measured as to solid content, followed by diluting with methylethylketone (MEK), thereby preparing a siloxane compound with a solid content of 10%.

TABLE 1

| | Composition | | |
|---|---|---|---|
| | | | Content of |
| | Metal salt | | siloxane |
| | Kind | Content (wt %) | compound (wt %) |
| Preparative Example 1-1 | FeCl₃ | 0.1 | 99 |
| Preparative Example 1-2 | CoCl₂ | 0.1 | 99 |
| Preparative Example 1-3 | CrO₃ | 0.1 | 99 |
| Preparative Example 1-4 | Mg(OEt)₂ | 0.1 | 99 |
| Preparative Example 1-5 | — | — | 100 |
| Preparative Example 1-6 | — | — | 100 |

### PREPARATIVE EXAMPLE 2

### Coating Composition for Hard Coating Layer

Based on 100 parts by weight of solids, 20 parts by weight of a dipentaerythritol hexaacrylate, 60 parts by weight of a UV-curable acrylate (HX-920UV, Kyoeisha Chemical Co., Ltd.), 15 parts by weight of silica nanoparticles (XBA-ST, Nissan Chemical Ind.), and 5 parts by weight of a photoinitiator (Irgacure-184, Ciba Specialty Chemicals) were mixed, followed by diluting with a diluting solvent of methylethylketone (MEK), thereby preparing a coating composition for hard coating layers with a solid content of 45% (index of refraction: 1.52).

### PREPARATIVE EXAMPLE 3

### Coating Composition for High Refractive-Index Layer

Based on 100 parts by weight of solids, 36 parts by weight of a UV-curable acrylate (HX-920UV, Kyoeisha Chemical Co., Ltd.), 60 parts by weight of high refractive nanoparticles (ZrO₂ nanoparticles), and 4 parts by weight of a photoinitiator (Irgacure-184, BASF) were mixed, followed by diluting with a diluting solvent of methylethylketone (MEK), thereby preparing a coating composition for a high refractive-index layer with a solid content of 5% (index of refraction: 1.64).

### EXAMPLES AND COMPARATIVE EXAMPLES

### Example 1

The coating composition for hard coating layers in Preparative Example 2 was coated onto a 125 μm thick PET film to a dried film thickness of 1.5 μm using a Meyer bar, followed by curing through UV irradiation at 300 mJ using a 180 W high voltage mercury lamp, thereby preparing a hard coating film. Next, the coating composition for a hard coating layer of Preparative Example 2 was coated onto the other surface of the film to a dried film thickness of 1.5 μm and then cured in the same manner, thereby preparing a film having a hard coating layer on both surfaces thereof.

Thereafter, the coating composition for a high refractive-index layer in Preparative Example 3 was coated onto one surface of the film with a hard coating layer on both surfaces thereof to a dried film thickness of 50 nm, followed by curing through UV irradiation at 300 mJ using a 180 W high voltage mercury lamp, thereby forming a high refractive-index layer.

Next, the coating composition prepared in Preparative Example 1-1 was coated onto the high refractive-index layer to a dried film thickness of 20 nm, followed by curing in an oven at 150° C. for 1 minute, thereby forming a low refractive-index layer. Here, an ITO layer having a film thickness of 20 nm was formed on the low refractive-index layer using an ITO target with a ratio of indium to tin of 95:5, thereby preparing a transparent conductive film.

### Example 2

A transparent conductive film was prepared in the same manner as in Example 1 except that the coating composition prepared in Preparative Example 1-2 was used, and the low refractive-index layer was formed to a thickness of 40 nm.

### Example 3

A transparent conductive film was prepared in the same manner as in Example 1 except that the coating composition prepared in Preparative Example 1-3 was used, and the low refractive-index layer was formed to a thickness of 50 nm.

### Example 4

A transparent conductive film was prepared in the same manner as in Example 1 except that the coating composition prepared in Preparative Example 1-4 was used, and the low refractive-index layer was formed to a thickness of 60 nm.

### Comparative Example 1

A transparent conductive film was prepared in the same manner as in Example 1 except that the coating composition prepared in Preparative Example 1-5 was used, and the low refractive-index layer was formed to a thickness of 100 nm.

### Comparative Example 2

A transparent conductive film was prepared in the same manner as in Example 1 except that the coating composition prepared in Preparative Example 1-6 was used, and the low refractive-index layer was formed to a thickness of 100 nm.

### Experimental Example

### Physical Properties of Transparent Conductive Film

For each of the transparent conductive films prepared in Examples and Comparative Examples, the following properties were measured. Results are shown in Table 2.

1) Acid stability evaluation: A photosensitive resin was coated onto the low refractive-index layer using a patterned silk screen, followed by dipping in a 5% aqueous hydrochloric acid at 25° C. subsequent to drying and curing. Next, the pattern was observed with the naked eye to determine whether the low refractive-index layer suffered from damage caused by the acid solution.

2) Transmittance and transmissive b*/reflective b*: Total luminous transmittance and transmissive b*/reflective b* values were measured using a CM-5 (Konica Minolta Co., Ltd).

3) Haze: Haze was measured using a CM-5 (Konica Minolta Co., Ltd).

4) Coatability: The transparent conductive film was observed with the naked eye and then observed using an optical microscope AM413T Dino-Lite Pro, thereby evaluating coatability of the transparent conductive film.

5) Adherence: A surface of the transparent conductive film was cut into a lattice of 10 mm×10 mm (length×width) squares at intervals of 1 mm using a cutter, followed by conducting a peel test using a cellophane adhesive tape (Nichiban Co., Ltd). The peel test was repeated three times for the same portion using the tape. The number of unpeeled square portions was identified and indicated based on 100 portions (n/100).

TABLE 2

| | | | | | Comp. | Comp. |
|---|---|---|---|---|---|---|
| | Example 1 | Example 2 | Example 3 | Example 4 | Example 1 | Example 2 |
| Damage by acid | X | X | X | X | Δ | ◯ |
| Transmittance (%) | 90.0 | 90.6 | 90.7 | 90.8 | 90.6 | 90.5 |
| Transmissive b* | 0.66 | 0.42 | 0.18 | 0.51 | 0.38 | 0.43 |
| Reflective b* | −1.16 | −0.19 | 0.97 | −0.55 | −0.36 | −0.18 |
| Haze | 0.29 | 0.3 | 0.29 | 0.27 | 0.3 | 0.31 |
| Coatability | ◯ | ⊚ | ⊚ | ◯ | ◯ | Δ |
| Adherence | 100/100 | 100/100 | 100/100 | 100/100 | 100/100 | 100/100 |

<Damage by Acid> - ◯: severe damage, Δ: normal damage, X: No damage
<Coatability> - ⊚: excellent, ◯: good, Δ: normal, X: poor

It could be confirmed from the results in Table 2 that the transparent conductive films of Examples 1 to 4 exhibited optical properties, coatability, and adherence above a certain level, and suffered from little or no damage caused by acids. Particularly, in acid stability evaluation, it was observed with the naked eye that the low refractive-index layer formed using the coating composition for a low refractive-index layer including the metal salt had a denser structure and thus suffered from little or no damage by an etching solution, i.e. an acidic solution.

On the other hand, although the transparent conductive films of Comparative Examples 1 to 2 exhibited similar transmittance, transmissive b*, and reflective b* values to those of Examples 1 to 4, and exhibiting above-normal coatability and adherence, the transparent conductive films of Comparative Examples 1 to 2 which included the low refractive-index layer formed using the coating composition for a low refractive-index layer not including the metal salt were damaged by an etching solution, i.e. an acidic solution in acid stability evaluation.

Consequently, it could be seen that the low refractive-index layer formed using the coating composition for a low refractive-index layer including the siloxane compound and the metal salt and the transparent conductive film including the low refractive-index layer were prevented from damage by acid by virtue of the metal salt. Therefore, it can be inferred that the low refractive-index layer protected the transparent conductive film from an etching solution for patterning of a conductive layer while securing barrier properties to volatile gases or the like generated from the transparent substrate.

1. A coating composition for a low refractive-index layer comprising: a siloxane compound; and a metal salt.

2. The coating composition according to claim 1, wherein the metal salt comprises a salt of at least one metal selected from the group consisting of zinc, yttrium, trivalent chromium, di- and trivalent cobalt, nickel, magnesium, aluminum, mono- and divalent copper, trivalent iron, cadmium, antimony, mercury, rubidium, vanadium, and combinations thereof.

3. The coating composition according to claim 1, wherein the metal salt comprises at least one salt selected from the group consisting of nitrates, sulfates, carboxylates, halides, alkoxides, acetyl acetonate, and combinations thereof.

4. The coating composition according to claim 1, wherein the metal salt is present in an amount of 0.1 wt % to 1.0 wt % based on the total weight (100 wt %) of the coating composition.

5. The coating composition according to claim 1, wherein the siloxane compound comprises a siloxane polymer selected from the group consisting of tetramethoxysilane, tetraethoxysilane, methyltrimethoxysilane, glycidyloxypropyltrimethoxysilane, and combinations thereof.

6. The coating composition according to claim 5, wherein the siloxane polymer has a molecular weight of about 1,000 to about 50,000.

7. The coating composition according to claim 1, wherein the siloxane compound is present in an amount of 5 wt % to 100 wt % based on the total weight (100 wt %) of the coating composition.

8. A transparent conductive film comprising: a low refractive-index layer formed using the coating composition for a low refractive-index layer according to claim 1.

9. The transparent conductive film according to claim 8, wherein the transparent conductive film has a laminate structure of a transparent substrate, a high refractive-index layer, the low refractive-index layer, and a conductive layer.

10. The transparent conductive film according to claim 8, wherein the low refractive-index layer has an index of refraction of 1.4 to 1.5.

11. The transparent conductive film according to claim 8, wherein the low refractive-index layer has a thickness of 5 nm to 100 nm.

12. The transparent conductive film according to claim 9, wherein the high refractive-index layer has a thickness of 20 nm to 150 nm.

13. The transparent conductive film according to claim 9, wherein the transparent substrate is a monolayer or multilayer film comprising any one selected from the group consisting of polyethylene terephthalate (PET), polyethylene naphthalate (PEN), polyethersulfone (PES), polycarbonate (PC), polypropylene (PP), polyvinyl chloride (PVC), polyethylene (PE), polymethyl methacrylate (PMMA), ethylene vinyl alcohol (EVA), polyvinyl alcohol (PVA), and combinations thereof.

14. The transparent conductive film according to claim 9, wherein the conductive layer comprises indium tin oxide (ITO) or fluorine-doped tin oxide (FTO).

15. The transparent conductive film according to claim 9, further comprising: a hard coating layer on one or both surfaces of the transparent substrate.
